(19) United States
(12) Patent Application Publication
(10) Pub. No.: US 2014/0109663 A1
(43) Pub. Date: Apr. 24, 2014

(54) Flowmeter for Installation Under Pressure, Equipment for Installing the Flowmeter, and Installation Method

(71) Applicants: Roger Dennison, Lexington, MA (US); Christopher Corsino, Lakeville, MA (US)

(72) Inventors: Roger Dennison, Lexington, MA (US); Christopher Corsino, Lakeville, MA (US)

(73) Assignee: CDI Meters, Inc., Woburn, MA (US)

(21) Appl. No.: 13/916,119

(22) Filed: Jun. 12, 2013

Related U.S. Application Data
(60) Provisional application No. 61/715,904, filed on Oct. 19, 2012.
(60) Provisional application No. 61/722,833, filed on Nov. 6, 2012.

(51) Int. Cl. G01F 1/684

(52) U.S. Cl. CPC G01F 1/684
USPC 73/204.11; 29/428

(57) ABSTRACT

A flowmeter of the thermal type, having a heated flow-sensing element and a temperature-sensing reference element, the elements constructed and arranged to be installed in a pressurized pipe. The flowmeter has one probe with the heated element and a separate second probe with the reference element. The probes are constructed and arranged to pass through the pipe wall in separate through-holes. There is a mounting structure such as a split ring that is adapted to be mounted to the pipe. Two valves operatively coupled to separate locations of the mounting structure, where one probe passes through each valve and into the pipe.

### CROSS-REFERENCE TO RELATED APPLICATIONS

This application claims priority of two Provisional Patent Applications, the disclosures of which are incorporated herein by reference: application Ser. No. 61/715,904, filed on Oct. 19, 2012, and application Ser. No. 61/722,833 filed on Nov. 6, 2012.

### FIELD

A thermal flowmeter designed for easy installation in a pressurized compressed-air pipe.

### BACKGROUND

Thermal flowmeters operate on the well-known thermal principal by which one element is heated and maintained warmer than a second element; the amount of heat required to maintain the temperature difference is a measure of the fluid mass velocity. The two elements are normally built into a single probe. When the flowmeter is to be installed into a pressurized pipe, the probe is inserted through a valve into the pipe. The probe has a relatively large diameter and so a large hole, typically ⅝ inch in diameter or larger, must be drilled in the pipe. The force exerted by the compressed air on a drill entering the pipe is sufficient to require specialized equipment to restrain the drill.

### SUMMARY

The subject flowmeter operates on the thermal principal by which one element is heated and maintained warmer than a second element, the amount of heat required to maintain the temperature difference being a measure of the fluid mass velocity. The two elements are separated and placed in small probes that can be inserted into the pipe through small holes that are easily drilled in the pipe. The flowmeter thus can be installed in a pipe that is in-service.

The flowmeter may include a split ring suitable for clamping around a pipe, two valves mounted in the ring, mounting fittings, two probe assemblies, an electronic enclosure that is electrically connected to the probe assemblies and containing electronics to measure, report and display flow, and a removable drill guide and filter assembly for use during installation. There may be a drill bit having a long shank and a short flute that is used during installation.

To install the flowmeter on a pipe containing compressed air, the user clamps the split ring to the pipe, and then installs each probe by drilling a hole in the pipe through the corresponding valve, partially withdrawing the drill so that chips vent into the filter, closing the valve, and then inserting the probe through the valve and securing it in place. The user then connects power to the meter and it will display flow.

This disclosure features a flowmeter of the thermal type, having a heated flow-sensing element and a temperature-sensing reference element, the elements constructed and arranged to be installed in a pressurized pipe, comprising one probe with the heated element and a separate second probe with the reference element. The probes are constructed and arranged to pass through the pipe wall in separate through-holes.

The flowmeter may further comprise a mechanical mounting structure that is adapted to be mounted to the pipe. The flowmeter may further comprise two valves operatively coupled to separate locations of the mounting structure, where one probe passes through each valve and into the pipe. The mechanical mounting structure may be a split ring and the valves may be ball valves.

The flowmeter may further comprise two mounting fittings, one coupled to each valve. The mounting fittings may comprise enlarged head structures projecting from a top surface. The mounting fittings may further comprise a central opening to receive a probe. The probes may each be part of separate probe assemblies. Each probe assembly may comprise a base portion with a central hole in which a probe is located and two slotted holes that are constructed and arranged to engage the enlarged head structures. Each probe assembly may further comprise structure to hold a safety cable. The safety cables may also be coupled to the mechanical mounting structure. Each probe assembly may further comprise an o-ring seal located in a recess and surrounding the central hole. The flowmeter may further comprise a drill guide and filter assembly adapted to be releasably coupled to the mounting fitting. The drill guide and filter assembly may comprise a drill guide assembly with a longitudinal opening that is adapted to receive a drill bit. The drill guide and filter assembly may further comprise a filter that is fluidly coupled to the opening at a coupling location. The longitudinal opening may be larger below the

coupling location than it is above the coupling location. The flowmeter may further comprise an O-ring that forms a seal between the mechanical structure and the pipe, where the O-ring is separated from the path of the drill by a solid barrier.

Also featured is a method of installing a flowmeter as described above, comprising the following steps: providing the mechanical mounting structure, coupling the valves to the mechanical mounting structure, coupling a mounting fitting to each of the valves, coupling the mechanical mounting structure, valves and mounting fittings combination to the pipe, coupling the drill guide and filter assembly to one mounting fitting, passing a drill bit through the drill guide and filter assembly, the mounting fitting and the valve, and drilling a hole in the pipe, after the hole is drilled withdrawing the drill bit far enough to allow the valve to be closed and then closing the valve, removing the drill bit, removing the drill guide and filter assembly from the mounting fitting, and coupling a probe assembly to the mounting fitting.

The installation may be continued by then coupling the drill guide and filter assembly to the second mounting fitting, passing a drill bit through the drill guide and filter assembly, the mounting fitting and the valve, and drilling a hole in the pipe, after the hole is drilled withdrawing the drill bit far enough to allow the valve to be closed and then closing the valve, removing the drill bit, removing the drill guide and filter assembly from the mounting fitting, and coupling a probe assembly to the mounting fitting.

Also featured herein is a flowmeter of the thermal type, having a heated flow-sensing element and a temperature-sensing reference element, the elements constructed and arranged to be installed in a pressurized pipe, comprising one probe with the heated element, a separate second probe with the reference element wherein the probes are constructed and arranged to pass through the pipe wall in separate through-holes, a mechanical mounting structure that is adapted to be mounted to the pipe, two valves operatively coupled to separate locations of the mechanical mounting structure, where one probe passes through each valve and into the pipe, two mounting fittings, one coupled to each valve, where the mounting fittings comprise enlarged head structures projecting from a top surface and a central opening to receive a probe, wherein the probes are each part of separate probe assemblies, wherein each probe assembly comprises a base portion with a central hole in which a probe is located and two slotted holes that are constructed and arranged to engage the enlarged head structures, and a seal located in a recess and surrounding the central hole, a drill guide and filter assembly adapted to be releasably coupled to the mounting fitting, wherein the drill guide and filter assembly comprises a drill guide assembly with a longitudinal opening that is adapted to receive a drill bit and a filter that is fluidly coupled to the opening at a coupling location, wherein the longitudinal opening is larger below the coupling location than it is above the coupling location, and a seal between the mechanical structure and the pipe, where the seal is separated from the path of the drill by a solid barrier. Each probe assembly may further comprise structure to hold a safety cable, and the safety cables are also coupled to the mechanical mounting structure.

### BRIEF DESCRIPTION OF THE DRAWINGS

Other objects, features and examples will occur to those skilled in the art from the following description and the accompanying drawings, in which:

FIG. 1 is an overall view of a flowmeter mounted on a section of pipe.

FIG. 2 is an end view, partially in section, showing the probe assemblies inserted through the mounting fittings, the valves and the ring into the pipe.

FIG. 3 is an enlarged sectional view showing the 0-ring gasket surrounding one of the probes and compressed between the ring and the pipe.

FIG. 4 is a side view of the mounting fitting.

FIG. 5 is a top view of the probe assembly.

FIG. 6 is a sectional side view of the probe assembly.

FIG. 7 is a sectional side view of the drill guide and filter assembly

FIG. 8 is an illustration of the relation between the length of the flute of the drill and the dimensions of the other components, and

FIG. 9 is an illustration of the sequence of steps in the installation of the device.

### DETAILED DESCRIPTION

The disclosure includes a flow sensor of the thermal type designed for installation in a compressed-air line under pressure. The flowmeter can be used to sense the flow of compressed air. The flowmeter is of the thermal type with a heated probe and an unheated probe. The heated and unheated elements are in separate probes, and the probes are adapted for insertion through valves into a pipe. Accordingly, the required holes in the pipe are small and the attendant apparatus is compact, facilitating installation and allowing installation in a pipe that is in-use carrying compressed air.

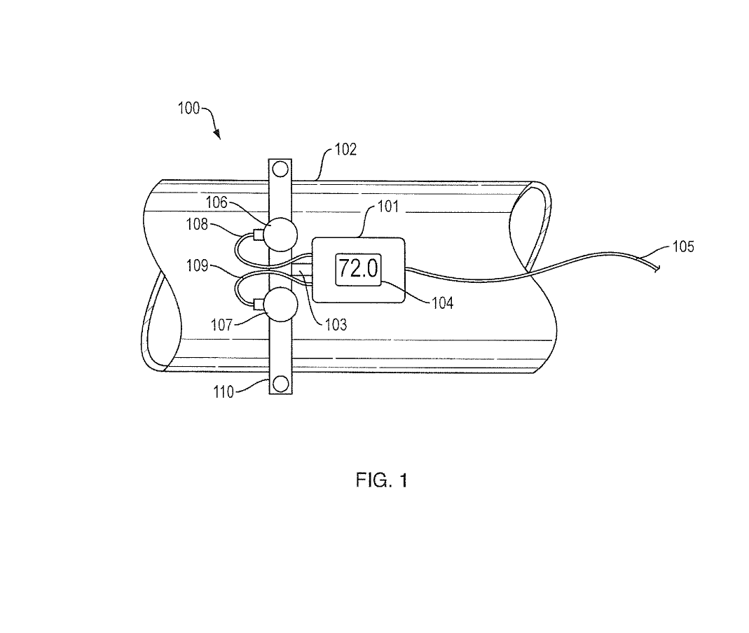

FIG. 1 is an overall view of one example of the disclosed flowmeter 100. A control enclosure 101 is mounted on a split ring 110 by bracket 103 which can include provisions (not shown) for the enclosure to be rotated to accommodate horizontal or vertical pipes. The control enclosure includes a display 104 and a cable 105 receiving power from an outside source. The control enclosure is connected to probe assemblies 106, 107 by cables 108, 109. Split ring 110 clamps to the pipe 102.

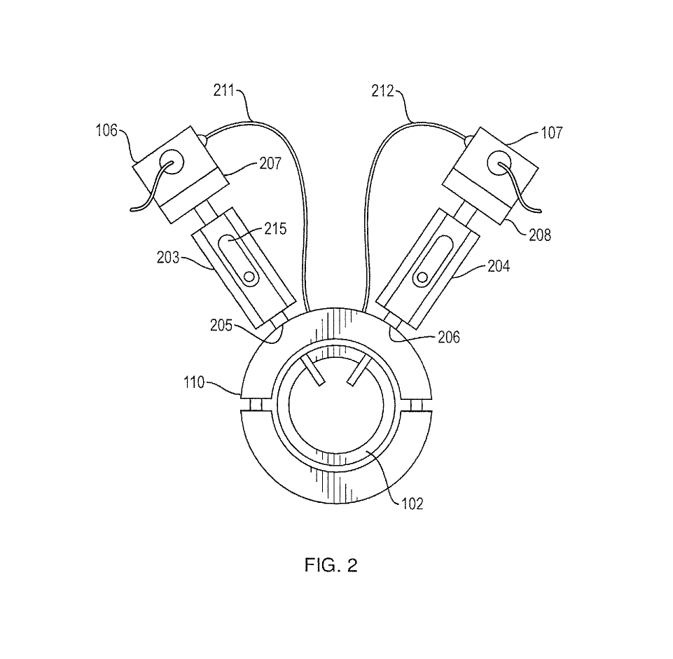

FIG. 2 is an end view showing the mounting of the probes. An appropriate mechanical mounting structure such as a split ring 110, typically made of aluminum, is clamped to pipe 102 by cap screws (not shown). The mounting structure could be something other than a split ring, e.g., a metal part affixed to the pipe by a band clamp or another type of clamp. Ball valves 203, 204 are threaded into the mounting structure in tapped holes 205, 206. These valves are preferably ⅛-inch pipe size, brass with stainless-steel balls, and with a male thread on one end and a female thread on the other. Other types of valves could be used, e.g., slide valves, plug valves or gate valves. Threaded into the valves are mounting fittings 207, 208, and affixed to these are probe assemblies 106, 107. Optional safety cables 211, 212 prevent ejection of the probe assemblies from the meter.

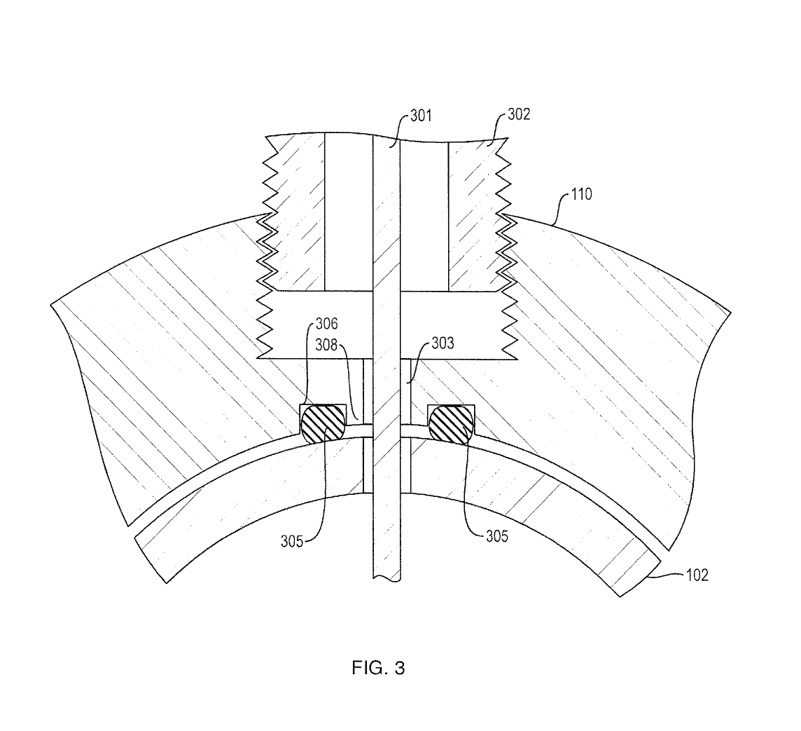

FIG. 3 is an enlarged sectional detail of the area where one of the probes enters the pipe. The probe 301 exits the male thread 302 at the base of the valve and passes through a close-fitting hole 303 in the ring 110. This hole constrains the motion of the probe. O-ring 305 in groove 306 forms a seal between the ring and the pipe 102. A wall of metal 308 separates the O-ring from the hole through which the drill passes to protect the O-ring when the hole in the pipe is being drilled.

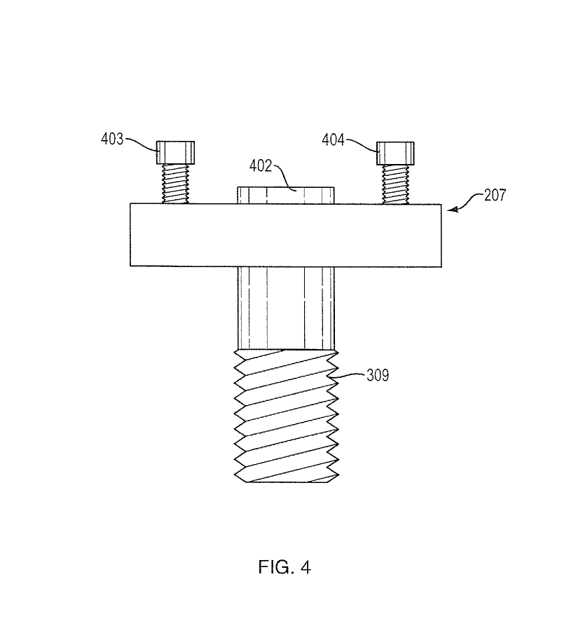

FIG. 4 shows one of the mounting fittings 207 which screw into the tops of the valves. It is typically made of aluminum or brass. It has a pipe thread 309 at its base to fit the thread in the valve, a raised circular portion 402 at the center of its top surface to center the drill guide, two socket head cap screws 403, 404 in threaded holes to engage the two parts that will, in succession, mount on it, and a drilled hole (not shown) in its center, slightly larger than the diameter of the drill that will pass through it.

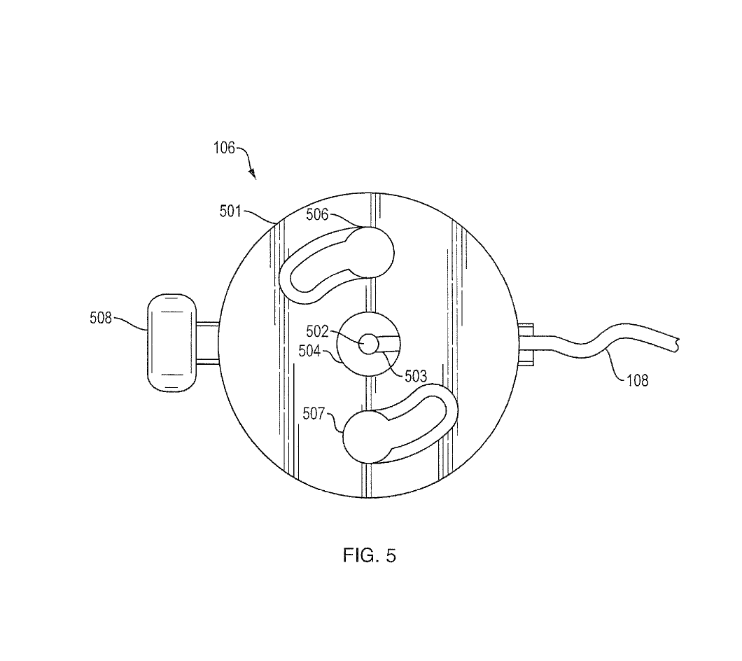

FIG. 5 is a top view of one of the probe assemblies 106. The base portion 501, typically made of aluminum, has a small hole in its center, 502 to receive the probe. Wires 503 from the probe pass through a space 504 at the center of the base portion and exit through one side as a cable 108. Two curved, slotted holes, 506, 507 are shaped to receive the cap screws 403 and 404 in FIG. 4 when the probe is inserted into the mounting fitting turned at an angle, and to engage them when it is rotated to its normal position. An enlarged-head projection (e.g., a knob) 508 provides for the attachment of a safety cable (not shown) to prevent the probe assembly from being ejected during or after assembly.

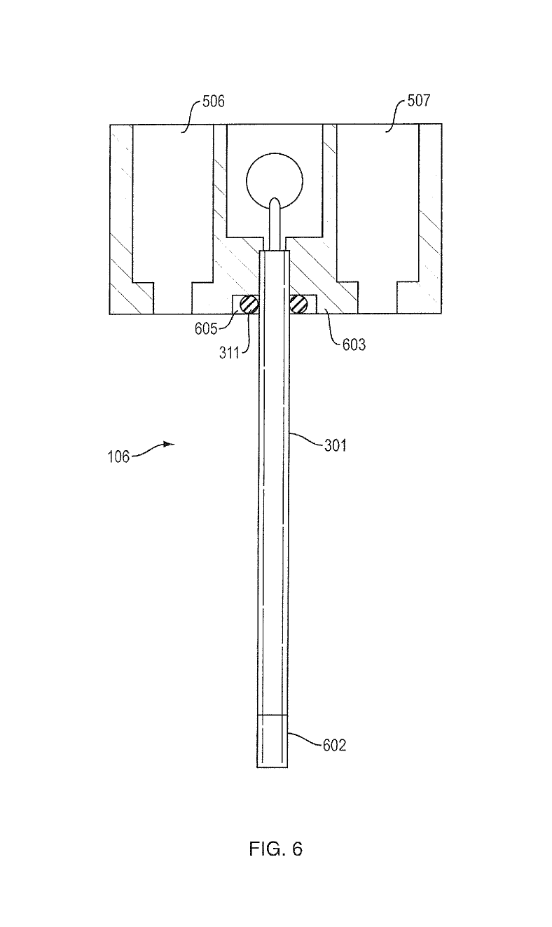

FIG. 6 is a partial sectional view of one probe assembly 106. It includes the probe 301 whose body is typically a stainless-steel tube, with a thermally-conductive tip 602 containing an RTD (not shown) and surrounded by the tube but exposed at the end. Thermal contact between the tip and the tube is provided by thermally-conductive epoxy, thermally-conductive silicone, or a similar material. Where the probe enters the base piece 603, it is held in place by epoxy or a similar adhesive (not shown) and surrounded by an O-ring 311 set in a groove 605.

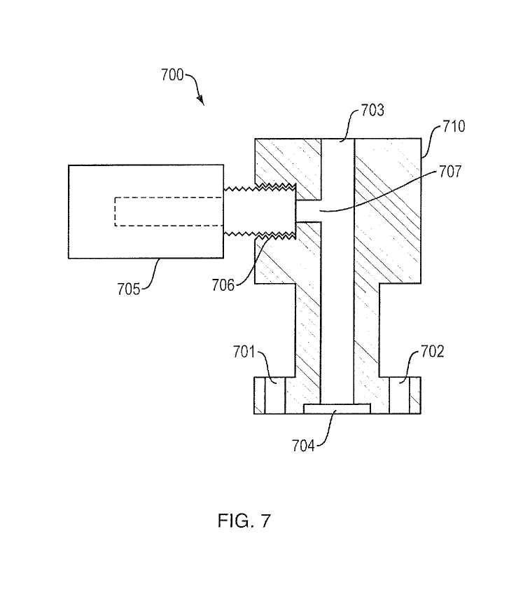

FIG. 7 is a sectional view of drill guide and filter assembly 700. The drill guide portion 710 may be made of aluminum, brass or steel. It has curved, slotted holes 701, 702 similar to those in the probe base to engage the cap screws in the mounting fitting. A hole 703 through the long axis of the portion 710 will receive the drill bit, while a circular recess 704 in the base will center it on the mounting fitting. The filter portion 705 is a commercially-available compressed-air muffler that is suitable for filtering particles from the air as well as muffling sound. It typically has a ⅛-inch male pipe-thread connection. It screws into a threaded hole 706 in the drill guide portion and connects to the hole 703 at the center of that portion at location 707. The diameter of the portion of hole 703 below location 707 is substantially larger than that of the drill bit, providing free passage of air from the flute of the drill to the muffler and space to collect chips from drilling, while the diameter of the portion of hole 703 above location 707 is essentially equal to the diameter of the drill bit, to inhibit the escape of air and metal chips.

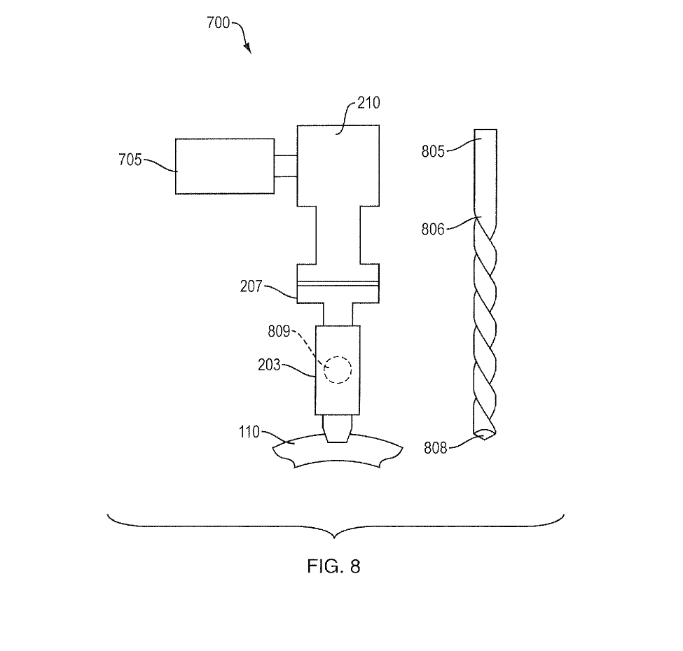

FIG. 8 illustrates the assembly of the parts for drilling and the length of the flute of the drill bit. The drill guide assembly 700 is shown mounted to the mounting fitting 207 which in turn is mounted on the valve 203 and the valve in turn is mounted on the split ring 110. Drill bit 805 is shown next to these assembled parts for clarity. The parts must be dimensioned so that the tip of the drill 808 can be above the top surface of the ball 809 of the valve 203 while the flute 806 is within the drill guide portion 210.

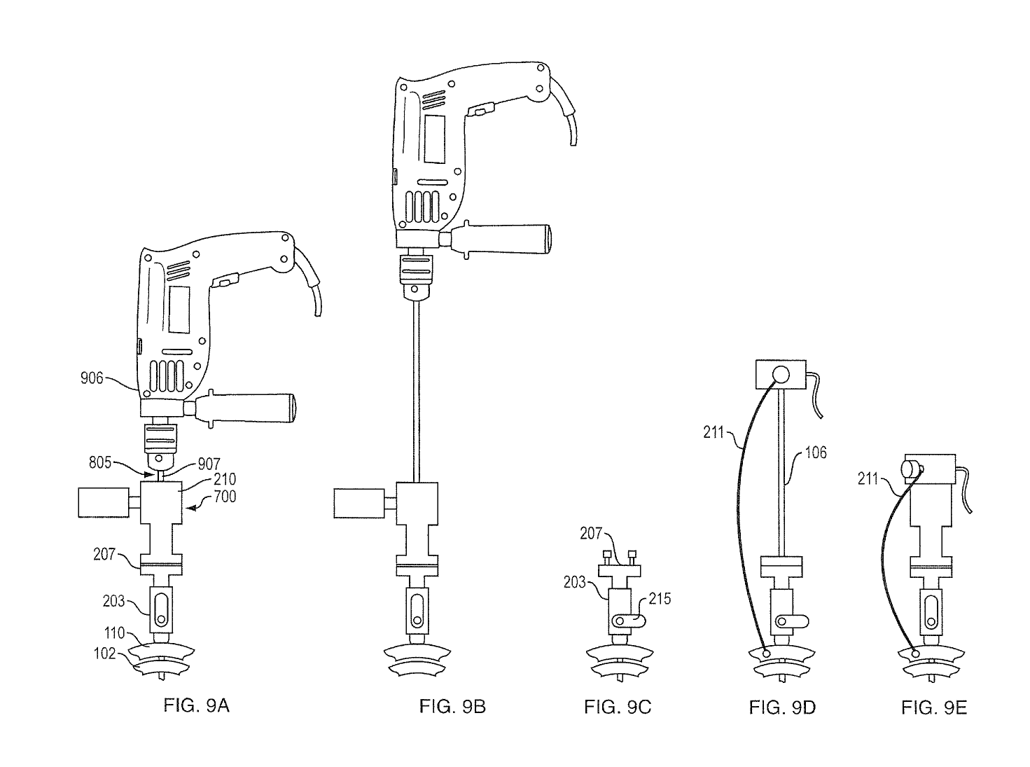

FIG. 9 illustrates the process of installing one of the probes in a pipe under pressure. The valve 203 and the mounting fitting 207 are supplied installed in the ring 110, and are held in place together and to the ring with epoxy, so as to control the depth of insertion of the probes into the pipe which is important to the accuracy of the meter. As shown in STEP 1, the user first securely clamps the ring 110 to the pipe 102 and affixes the drill guide 710 to the mounting fitting 207 and tightens the screws to secure it in place. Then, using drill guide assembly 700 and a long drill bit with a short flute 805, the user drills the hole in the pipe. (Gloves and full-face protection must be worn during this process.) Once the hole is drilled, air will flow from the inside of the pipe along the drill, through the valve, through the mounting fitting (the hole in which is slightly larger than the drill bit), and through the lower portion of the drill guide (where the hole is substantially larger than the drill bit) and into the filter. This flow of air will reduce the likelihood of chips from the drilling operation entering the pipe.

As shown in STEP 2, the user next retracts the drill bit to the point at which the top of the flute of the drill bit is within the drill guide. Air will then rush into the filter, taking most of the chips from the drilling operation with it. As shown in STEP 3, the user next withdraws the drill a short additional distance such that the bit is free of the valve, closes the valve via valve handle 215, removes the drill and removes the drill guide and filter assembly.

As shown in STEP 4, the user then inserts the probe assembly 106 into the mounting fitting 207. A safety cable 211 is connected from the split ring to the knob at this time to prevent the probe assembly from being pushed out of the hole by air pressure when the valve is opened. Gripping the probe assembly firmly, the operator then opens the valve, presses the probe the rest of the way through the valve and into the pipe, and rotates the probe assembly in order to engage the screws in the probe base. He then tightens the screws. The installed probe is shown as STEP 5.

Referring to FIG. 1, the user repeats the process for the second probe assembly 107 and connects power to the device through electrical cable 105. The device will then display flow of compressed air in the pipe.

Features of the claimed invention may be shown in some drawings and not others, and may not all be shown in the same drawing. The examples above support but do not limit the claims.

What is claimed is:

1. A flowmeter of the thermal type, having a heated flow-sensing element and a temperature-sensing reference element, the elements constructed and arranged to be installed in a pressurized pipe, comprising:
one probe with the heated element; and
a separate second probe with the reference element;
wherein the probes are constructed and arranged to pass through the pipe wall in separate through-holes.

2. The flowmeter of claim 1 further comprising a mechanical mounting structure that is adapted to be mounted to the pipe.

3. The flowmeter of claim 2 further comprising two valves operatively coupled to separate locations of the mounting structure, where one probe passes through each valve and into the pipe.

4. The flowmeter of claim 2 wherein the mechanical mounting structure comprises a split ring.

5. The flowmeter of claim 3 wherein the valves are ball valves.

6. The flowmeter of claim 1 further comprising two mounting fittings, one coupled to each valve.

7. The flowmeter of claim 6 wherein the mounting fittings comprise enlarged head structures projecting from a top surface.

8. The flowmeter of claim 7 wherein the mounting fittings further comprise a central opening to receive a probe.

9. The flowmeter of claim 8 wherein the probes are each part of separate probe assemblies.

10. The flowmeter of claim 9 wherein each probe assembly comprises a base portion with a central hole in which a probe is located and two slotted holes that are constructed and arranged to engage the enlarged head structures.

11. The flowmeter of claim 10 wherein each probe assembly further comprises structure to hold a safety cable.

12. The flowmeter of claim 11 wherein the safety cables are also coupled to the mechanical mounting structure.

13. The flowmeter of claim 10 wherein each probe assembly further comprises an O-ring seal located in a recess and surrounding the central hole.

14. The flowmeter of claim 10 further comprising a drill guide and filter assembly adapted to be releasably coupled to the mounting fitting.

15. The flowmeter of claim 14 wherein the drill guide and filter assembly comprises a drill guide assembly with a longitudinal opening that is adapted to receive a drill bit.

16. The flowmeter of claim 15 wherein the drill guide and filter assembly further comprises a filter that is fluidly coupled to the opening at a coupling location.

17. The flowmeter of claim 15 wherein the longitudinal opening is larger below the coupling location than it is above the coupling location.

18. The flowmeter of claim 17 further comprising an O-ring that forms a seal between the mechanical structure and the pipe, where the O-ring is separated from the path of the drill by a solid barrier.

19. A method of installing the flowmeter of claim 17 comprising:
providing the mechanical mounting structure;
coupling the valves to the mechanical mounting structure;
coupling a mounting fitting to each of the valves;
coupling the mechanical mounting structure, valves and mounting fittings combination to the pipe;
coupling the drill guide and filter assembly to one mounting fitting;
passing a drill bit through the drill guide and filter assembly, the mounting fitting and the valve, and drilling a hole in the pipe;
after the hole is drilled withdrawing the drill bit far enough to allow the valve to be closed and then closing the valve;
removing the drill bit;
removing the drill guide and filter assembly from the mounting fitting; and
coupling a probe assembly to the mounting fitting.

20. The method of claim 19 further comprising continuing the installation by then:
coupling the drill guide and filter assembly to the second mounting fitting;
passing a drill bit through the drill guide and filter assembly, the mounting fitting and the valve, and drilling a hole in the pipe;
after the hole is drilled withdrawing the drill bit far enough to allow the valve to be closed and then closing the valve;
removing the drill bit;
removing the drill guide and filter assembly from the mounting fitting; and
coupling a probe assembly to the mounting fitting.

21. A flowmeter of the thermal type, having a heated flow-sensing element and a temperature-sensing reference element, the elements constructed and arranged to be installed in a pressurized pipe, comprising:
one probe with the heated element;
a separate second probe with the reference element;
wherein the probes are constructed and arranged to pass through the pipe wall in separate through-holes;
a mechanical mounting structure that is adapted to be mounted to the pipe;
two valves operatively coupled to separate locations of the mechanical mounting structure, where one probe passes through each valve and into the pipe;
two mounting fittings, one coupled to each valve, where the mounting fittings comprise enlarged head structures projecting from a top surface and a central opening to receive a probe;
wherein the probes are each part of separate probe assemblies, wherein each probe assembly comprises a base portion with a central hole in which a probe is located and two slotted holes that are constructed and arranged to engage the enlarged head structures, and a seal located in a recess and surrounding the central hole;
a drill guide and filter assembly adapted to be releasably coupled to the mounting fitting, wherein the drill guide and filter assembly comprises a drill guide assembly with a longitudinal opening that is adapted to receive a drill bit and a filter that is fluidly coupled to the opening at a coupling location, wherein the longitudinal opening is larger below the coupling location than it is above the coupling location; and
a seal between the mechanical structure and the pipe, where the seal is separated from the path of the drill by a solid barrier.

22. The flowmeter of claim 21 wherein each probe assembly further comprises structure to hold a safety cable, and the safety cables are also coupled to the mechanical mounting structure.
